(19) United States
(12) Patent Application Publication
(10) Pub. No.: US 2011/0205849 A1
(43) Pub. Date: Aug. 25, 2011

(54) DIGITAL CALENDAR DEVICE AND METHODS

(75) Inventor: Feng Kang, San Diego, CA (US)

(73) Assignee: SONY CORPORATION, A JAPANESE CORPORATION, Tokyo (JP)

(21) Appl. No.: 12/711,183

(22) Filed: Feb. 23, 2010

(51) Int. Cl. G06F 3/048; G04B 19/24; G04B 47/00; G06F 17/21; G10L 13/08; G06F 3/041; G10L 15/26

(52) U.S. Cl. 368/10; 368/30; 715/764; 715/268; 704/260; 345/173; 704/235; 704/E13.001; 704/E15.043

(57) ABSTRACT

A digital calendar device involving an electronic device having a graphic user interface. The electronic device is capable of receiving at least one note from a user, and retrieving and displaying the at least one note, as well as running on at least one operating system. The digital calendar device further includes features, such retrieval and displaying features, a touch screen interface, handwriting support feature, a speech recognition feature, a reminder feature, a frame feature, a mechanical support feature, and a fortune-teller software program.

### CROSS-REFERENCE TO RELATED APPLICATION(S)

This document is related to U.S. patent application Ser. No. (to be assigned; Attorney Docket No. 95571 7114), entitled “Digital Calendar Device,” and filed contemporaneously with the present application, which is commonly owned, and which is hereby incorporated by this reference in its entirety.

### BACKGROUND OF THE INVENTION

1. Field of the Invention

The present invention generally relates to calendars. More specifically, the present invention generally relates to calendar devices and methods. Even more specifically, the present invention generally relates to electronic calendar devices and methods.

2. Discussion of the Related Art

In the related art, hard calendars have been used since ancient time. Examples of such hard calendars are the Aztec stone calendar and the Celtic stone calendar. In modern times, paper calendars, e.g., the leatherette covered paper folio calendars, are popular, but must be typically annually replaced. These paper calendars have inherent physical space limitations for writing notes. These related art hard calendars also do not have automatic reminder functions.

### SUMMARY OF THE INVENTION

Several embodiments of the invention advantageously address the needs above as well as other needs by providing a digital calendar device that is handy, quasi-portable, conducive to desktop use, and compatible with may operating systems.

In one embodiment, the invention can be characterized as a digital calendar device for desktop use comprising an electronic device having a graphic user interface, the electronic device capable of receiving at least one note from a user, and the electronic device capable of running on at least one operating system.

In an alternative embodiment, the invention can be characterized as a digital calendar device for both portable use and desktop use comprising an electronic device having a graphic user interface, the electronic device capable of receiving at least one note from a user, and the electronic device capable of running on at least one operating system.

In another embodiment, the invention can be characterized as a method of fabricating a digital calendar device comprising the step of providing an electronic device having a graphic user interface, the electronic device providing step comprising providing the electronic device as being capable of receiving at least one note from a user, and the electronic device providing step comprising providing the electronic device as being capable of running on at least one operating system.

In a further embodiment, the invention may be characterized as a method of calendaring, by way of a digital calendar device, comprising the steps of: providing an electronic device having a graphic user interface, the electronic device providing step comprising providing the electronic device as being capable of receiving at least one note from a user, and the electronic device providing step comprising providing the electronic device as being capable of running on at least one operating system; and entering the at least one note into the electronic device by the user through the graphic user interface.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a front view schematic representation of a digital calendar device for desktop use, in accordance with an embodiment of the present invention.

FIG. 2 is a perspective view schematic representation of a digital calendar device for both portable use and desktop use, in accordance with an alternative embodiment of the present invention.

FIG. 3 is a rear view schematic representation of a digital calendar device for both portable use and desktop use, in accordance with the embodiment of the present invention as shown in FIG. 2.

FIG. 4 is a perspective view schematic representation of a feature for mechanically supporting a digital calendar device for desktop use, in accordance with the embodiments of the present invention as shown in FIGS. 1 and 2.

FIG. 5 is a flowchart of a method of fabricating a digital calendar device, in accordance with another embodiment of the present invention.

FIG. 6 is a flowchart of a method of calendaring by way of a digital calendar device, in accordance with yet another embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention.

Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Some embodiments of the present invention generally involve a digital calendar device comprising an electronic device having a graphic user interface, the electronic device capable of receiving at least one note from a user, and the electronic device capable of running on at least one operating system.

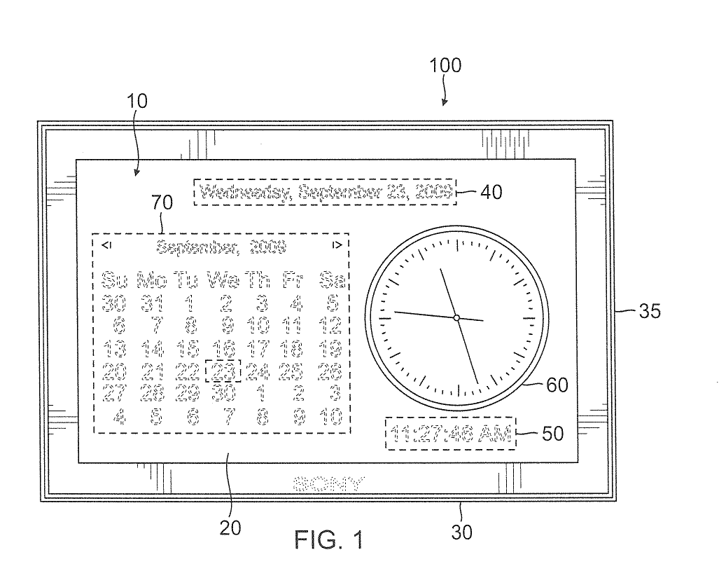

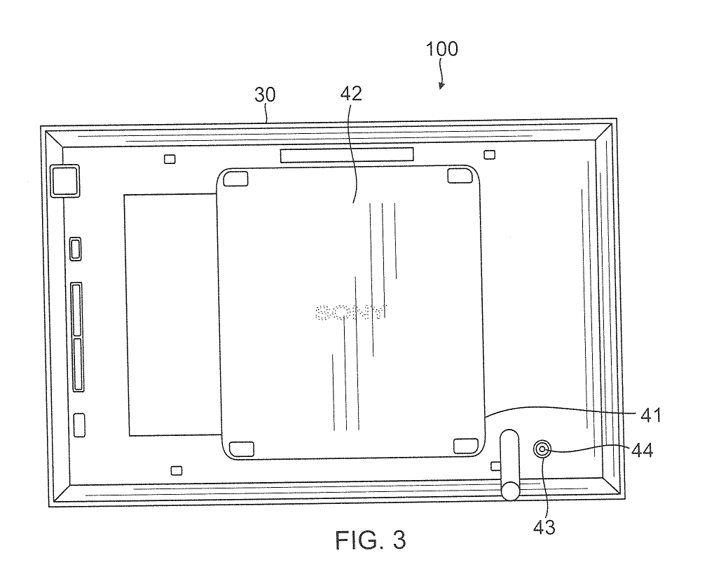

Referring first to FIG. 1, this front view schematic representation illustrates a digital calendar device 100, comprising an electronic device 10 having a graphic user interface (not shown), the electronic device 10 capable of receiving random information, e.g., at least one note (not shown), from a user (not shown), and the electronic device 10 capable of running on at least one operating system (not shown), in accordance with an embodiment of the present invention. The digital calendar device 100 further comprises one or more of the following features: a feature for retrieving and displaying the random information, e.g., the at least one note (not shown); a touch screen interface 20 for facilitating entry of the random information, e.g., at least one note by the user (not shown); a feature for supporting handwriting (not shown); a feature for supporting speech (not shown); a stylus 39; a feature for reminding the user of an upcoming event (not shown); a feature for translating handwriting into speech (not shown); a frame member 30 for accommodating the electronic device 10, a feature for mechanically supporting the electronic device on a desktop, such as a bracket 35; a fortune teller software program (FIG. 3); a feature (not shown) for providing a date stamp 40, a feature (not shown) for providing a time stamp 50; and a clock feature 60. The fortune teller program may comprise at least one feature, such as a horoscope feature, a feature for predicting lucky or unlucky future events for a given day, a feature for providing advice for avoiding future unlucky events, a feature for providing lucky numbers for a given day, and a feature for visually telling fortune, e.g., by text, and audibly telling fortune, e.g., by voice. The digital calendar device 100 may further comprise at least one of the following features: a USB port (not shown) for facilitating data transfer of data, such as scheduling information and notes from an external source, e.g., for facilitating transmission of the random information between the electronic device and a computer, e.g., a flash memory drive or a hard drive, such as a memory device for facilitating transmission of the random information between the electronic device and a computer or a memory card for facilitating transmission of the random information between the electronic device and a computer; an automatic orientation sensor for automatically selecting an orientation, e.g., self-orienting the device 100 in a portrait orientation or a landscape orientation by sensing a placement of the device 100 on a surface. The digital calendar device 100 may operate on either AC power via an AC adapter 43 or battery power via at least one battery 42 (FIG. 3). The electronic device 10 has a power-consumption in a range of approximately 7 W to approximately 7.7 W. The clock feature 60 may further comprise an element such as an atomic clock for precise automatic synchronization (not shown) and an alarm feature (not shown).

Still referring to FIG. 1, the retrieving and displaying feature may comprise a display, such as a liquid crystal display (LCD), e.g., in WVGA (800×480) resolution, and a plasma display panel (PDP). The digital calendar device 100 may further comprise a remote control (not shown) for facilitating navigation of the digital calendar device 100 from a distance, a power switch (not shown), and an AC adapter (not shown). The at least one operating system comprises at least one element, such as a Linux® operating system, a Windows® operating system, a WinCE® operating system, a Macintosh® operating system, and a any other embedded operating system. The handwriting supporting feature comprises at least one feature, such as a feature for recognizing handwriting, a feature for displaying handwriting, and a feature for translating handwriting into speech. The speech supporting feature comprises at least one feature, such as a feature for recognizing speech, a feature for transmitting speech, and a feature for translating speech into writing. Also, the digital calendar device 100 comprises a feature for storing at least one year of calendar information. The storing feature comprises an internal storage capacity in a range of approximately 64 MB. The digital calendar device 100 may further comprise a power button 36 for switching power to the electronic device 10 as well as a home button 37 for switching to a home screen that links to at least one feature, such as the retrieving and displaying feature for entry and display of the at least one note, the calendar feature 70, the clock feature 60, and the fortune teller program (not shown). The frame member 30 may comprise a recess 38 for accommodating the stylus 39. The frame 30 further comprises a feature 41 for accommodating at least one battery 42 for powering the electronic device 10 and an AC adapter 43 (FIG. 3).

Still referring to FIG. 1, the digital calendar device 100 comprises a size that is generally suitable for desktop use in a range of approximately that of an average paper table calendar. The size comprises at least one dimensional range, such as a width in a range of approximately 100 mm to approximately 300 mm, preferably in a width range of approximately 150 mm to approximately 200 mm, and preferably in a width of approximately 180 mm; a height in a range of approximately 75 mm to approximately 200 mm, preferably in a height range of approximately 100 mm to approximately 160 mm, and preferably in a height of approximately 130 mm; and a thickness in a range of approximately 0.1 mm to approximately 20 mm, preferably in a thickness range of approximately 5 mm to approximately 15 mm, and preferably in a thickness of approximately 10 mm. The touch screen interface 20 also comprises an aspect ratio in a range of approximately 1:1 to approximately 1:2, preferably an aspect ratio of approximately 0.72:1.

Still referring to FIG. 1, the electronic device 10 may be disposed within, and/or mechanically coupled with, the frame member 30. The mechanically supporting feature may comprise a bracket 35 that pivots for propping the digital calendar device 100 on horizontal surface (not shown) and that is mountable on a vertical surface (not shown) or an angled surface (not shown), such as by a hook (not shown). The retrieving and displaying feature (not shown), the touch screen interface 20, the handwriting supporting feature (not shown), the speech supporting feature (not shown), the stylus 39, the reminding feature (not shown), the fortune teller software program (not shown), the date stamp 40 providing feature, a time stamp 50 providing feature, the clock feature 60, and the storing feature (not shown) are in electronic communication with the electronic device 10. The USB port (not shown) and the automatic orientation sensor (not shown) are electronically coupled with the electronic device 10. The random information, e.g., the at least one note (not shown), is stored in the storing feature (not shown) and displayed by the retrieving and displaying feature (not shown). The remote control (not shown) is optionally included with the digital calendar device 100, e.g., as part of a kit, by example only. The at least one operating system (not shown) comprises is embedded in the electronic device 10. The handwriting supporting feature (not shown) is in electronic communication with the retrieving and displaying feature (not shown) and may be in electronic communication with the speech supporting feature (not shown).

Still referring to FIG. 1, in practice, the retrieving and displaying feature (not shown) provides a graphical representation of any given period of time, such as seconds, minutes, hours, days, weeks, months, or years, in at least one manner, such as a single image, a thumbnail view for facilitating quick searching (not shown), a scroll format (not shown), and a slide format (not shown). The user may also create a schedule by the hour or the minute. The schedule detail, e.g., in the faun of the at least one note (not shown), can be handwritten by using the stylus 39 or by using a soft keyboard (not shown), e.g., an on-screen keyboard, by way of the handwriting supporting feature (not shown). A reminder regarding a scheduled event is provided by the digital calendar device 100 by an indication (not shown), such as an audible indication, e.g., a sound/melody, and/or a visual indication, e.g., a graphical representation. In addition, the events in a calendar that have been entered in handwriting by the user can be translated into speech by the digital calendar device 100. Conversely, the events in a calendar that have been entered as speech by the user can be translated into writing by the digital calendar device 100. Further, the digital calendar device 100 can exchange calendar information (not shown) with a computer (not shown) by memory device (not shown), such as memory card (not shown) or through a USB cable (not shown). The random information, e.g., the at least one note (not shown), is entered by the user by way of the touch screen interface 20 using an on-screen keyboard (not shown) or a stylus 39. The handwriting supporting feature (not shown) also allows the user to enter random information (not shown), e.g., a telephone number, a cellular phone number, an e-mail address, or at the at least one note. The handwriting supporting feature (not shown) also facilitates entry of the random information, e.g., the at least one note (not shown) in a plurality of pages (not shown) which would be otherwise impossible using a related art hard calendar (not shown). The fortune teller program (not shown) may provide “future” information (not shown), such as a horoscope, a prediction of lucky or unlucky future events for a given day, advice for avoiding a future unlucky event, lucky numbers for a given day, a fortune telling that is provided visually, e.g., by text, and/or audibly, e.g., by voice. The digital calendar device 100 may operate on either AC power via an AC adapter 43 or battery power via at least one battery 42 (FIG. 3). The electronic device 10 has a power-consumption in a range of approximately 7 W to approximately 7.7 W.

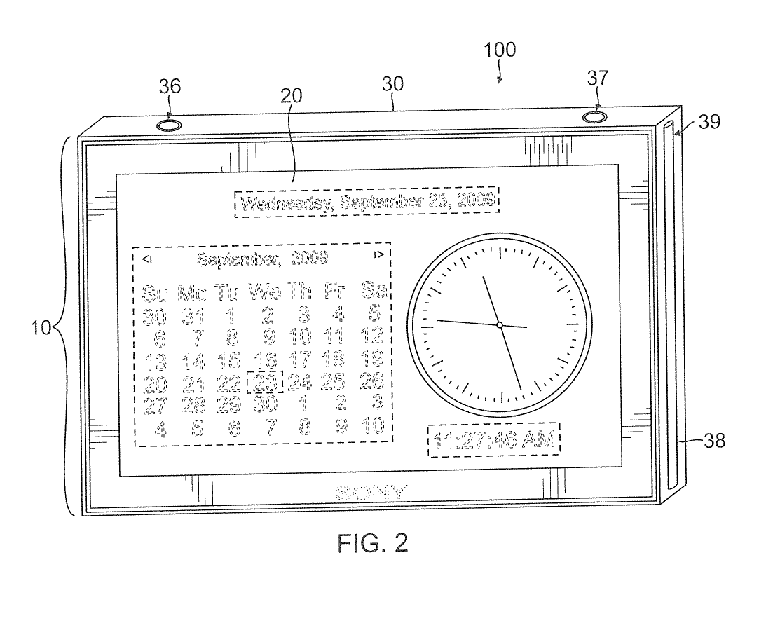

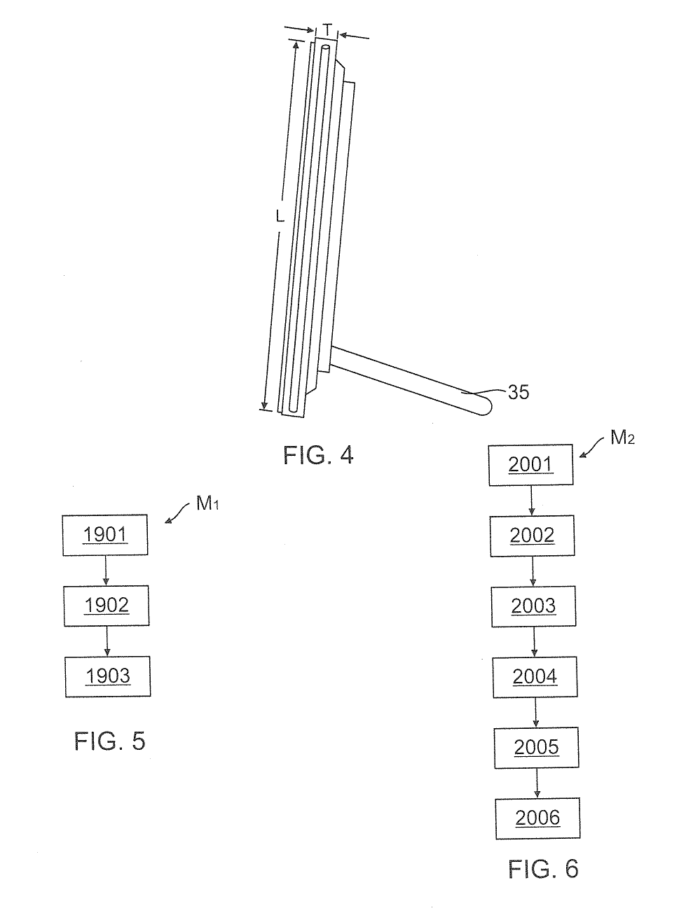

Referring next to FIG. 2, the digital calendar device 100 comprises an electronic device 10 that is handheld, such as a personal digital assistant (PDA) or other such small computing device, and that primarily replaces traditional hard calendars, e.g., table calendars or paper calendars, in accordance with an alternative embodiment of the present invention. While the digital calendar device 100 of this embodiment may be portable, the digital calendar device 100 is primarily intended for table top or a desktop. The digital calendar device 100 further comprises one or more of the following features: a feature for retrieving and displaying the random information, e.g., the at least one note (not shown); a touch screen interface 20 for facilitating entry of the random information, e.g., the at least one note by the user (not shown); a feature for supporting handwriting (not shown); a feature for supporting speech (not shown); a stylus 39; a feature for reminding the user of an upcoming event (not shown); a feature for translating handwriting into speech (not shown); a frame member 30 for accommodating the electronic device 10, a feature for mechanically supporting the electronic device on a desktop, such as a bracket 35 (FIG. 4); a fortune teller software program (not shown); a feature (not shown) for providing a date stamp 40, a feature (not shown) for providing a time stamp 50; and a clock feature 60. The fortune teller program may comprise at least one feature, such as a horoscope feature, a feature for predicting lucky or unlucky future events for a given day, a feature for providing advice for avoiding future unlucky events, a feature for providing lucky numbers for a given day, and a feature for visually telling fortune, e.g., by text, and audibly telling fortune, e.g., by voice. The digital calendar device 100 may further comprise at least one of the following features: a USB port (not shown) for facilitating data transfer of data, such as scheduling information and notes from an external source, e.g., for facilitating transmission of the random information between the electronic device and a computer, e.g., a flash memory drive or a hard drive, such as a memory device for facilitating transmission of the random information between the electronic device and a computer or a memory card for facilitating transmission of the random information between the electronic device and a computer; an automatic orientation sensor for automatically selecting an orientation, e.g., self-orienting the device 100 in a portrait orientation or a landscape orientation by sensing a placement of the device 100 on a surface.

Still referring to FIG. 2, the retrieving and displaying feature may comprise a display, such as a liquid crystal display (LCD), e.g., in WVGA (800×480) resolution, and a plasma display panel (PDP). The digital calendar device 100 may further comprise a remote control (not shown) for facilitating navigation of the digital calendar device 100 from a distance, a power switch (not shown), and an AC adapter (not shown). The at least one operating system comprises at least one element, such as a Linux® operating system, a Windows® operating system, a WinCE® operating system, a Macintosh® operating system, and a any other embedded operating system. The handwriting supporting feature comprises at least one feature, such as a feature for recognizing handwriting, a feature for displaying handwriting, and a feature for translating handwriting into speech. The speech supporting feature comprises at least one feature, such as a feature for recognizing speech, a feature for transmitting speech, and a feature for translating speech into writing. Also, the digital calendar device 100 comprises a feature for storing at least one year of calendar information. The storing feature comprises an internal storage capacity in a range of approximately 64 MB. The digital calendar device 100 may further comprise a power button 36 for switching power to the electronic device 10 as well as a home button 37 for switching to a home screen that links to at least one feature, such as the retrieving and displaying feature for entry and display of the at least one note, the calendar feature 70, the clock feature 60, and the fortune teller program (not shown). The frame member 30 may comprise a recess 38 for accommodating the stylus 39. The frame 30 further comprises a feature 41 for accommodating at least one battery 42 for powering the electronic device 10 and an AC adapter 43 (FIG. 3). The clock feature 60 may further comprise an element such as an atomic clock for precise automatic synchronization (not shown) and an alarm feature (not shown).

Still referring to FIG. 2, the digital calendar device 100 comprises a size that is generally suitable for both portable use and desktop use in a range of approximately that of a small paper table calendar. The size comprises at least one dimensional range, such as a width in a range of approximately 100 mm to approximately 300 mm, preferably in a width range of approximately 150 mm to approximately 200 mm, and preferably in a width of approximately 180 mm; a height in a range of approximately 75 mm to approximately 200 mm, preferably in a height range of approximately 100 mm to approximately 160 mm, and preferably in a height of approximately 130 mm; and a thickness in a range of approximately 0.1 mm to approximately 20 mm, preferably in a thickness range of approximately 5 mm to approximately 15 mm, and preferably in a thickness of approximately 10 mm. The touch screen interface 20 also comprises an aspect ratio in a range of approximately 1:1 to approximately 1:2, preferably an aspect ratio of approximately 0.72:1.

Still referring to FIG. 2, the electronic device 10 may be disposed within, and/or mechanically coupled with, the frame member 30. The mechanically supporting feature may comprise a bracket 35 that pivots for propping the digital calendar device 100 on horizontal surface (not shown) and that is mountable on a vertical surface (not shown) or an angled surface (not shown), such as by a hook (not shown). The retrieving and displaying feature (not shown), the touch screen interface 20, the handwriting supporting feature (not shown), the speech supporting feature (not shown), the stylus 39, the reminding feature (not shown), the fortune teller software program (not shown), the date stamp 40 providing feature, a time stamp 50 providing feature, the clock feature 60, and the storing feature (not shown) are in electronic communication with the electronic device 10. The USB port (not shown) and the automatic orientation sensor (not shown) are electronically coupled with the electronic device 10. The random information, e.g., the at least one note (not shown) is stored in the storing feature (not shown) and displayed by the retrieving and displaying feature (not shown). The remote control (not shown) is optionally included with the digital calendar device 100, e.g., as part of a kit, by example only. The at least one operating system (not shown) comprises is embedded in the electronic device 10. The handwriting supporting feature (not shown) is in electronic communication with the retrieving and displaying feature (not shown) and may be in electronic communication with the speech supporting feature (not shown).

Still referring to FIG. 2, in practice, the retrieving and displaying feature (not shown) provides a graphical representation of any given period of time, such as seconds, minutes, hours, days, weeks, months, or years, in at least one manner, such as a single image, a thumbnail view for facilitating quick searching (not shown), a scroll format (not shown), and a slide format (not shown). The user may also create a schedule by the hour or the minute. The schedule detail, e.g., in the form of the at least one note (not shown), can be handwritten by using the stylus 39 or by using a soft keyboard (not shown), e.g., an on-screen keyboard, by way of the handwriting supporting feature (not shown). A reminder regarding a scheduled event is provided by the digital calendar device 100 by an indication (not shown), such as an audible indication, e.g., a sound/melody, and/or a visual indication, e.g., a graphical representation. In addition, the events in a calendar that have been entered in handwriting by the user can be translated into speech by the digital calendar device 100. Conversely, the events in a calendar that have been entered as speech by the user can be translated into writing by the digital calendar device 100. Further, the digital calendar device 100 can exchange calendar information (not shown) with a computer (not shown) by memory device (not shown), such as memory card (not shown) or through a USB cable (not shown). The random information, e.g., the at least one note (not shown) is entered by the user by way of the touch screen interface 20 using an on-screen keyboard (not shown) or a stylus 39. The handwriting supporting feature (not shown) also allows the user to enter random information (not shown), e.g., a telephone number, a cellular phone number, an e-mail address, or at the at least one note. The handwriting supporting feature (not shown) also facilitates entry of the random information, e.g., the at least one note (not shown) in a plurality of pages (not shown) which would be otherwise impossible using a related art hard calendar (not shown). The fortune teller program (not shown) may provide “future” information (not shown), such as a horoscope, a prediction of lucky or unlucky future events for a given day, advice for avoiding a future unlucky event, lucky numbers for a given day, a fortune telling that is provided visually, e.g., by text, and/or audibly, e.g., by voice. The digital calendar device 100 may operate on either AC power via an AC adapter 43 or battery power via at least one battery 42 (FIG. 3). The electronic device 10 has a power-consumption in a range of approximately 7 W to approximately 7.7 W.

Referring next to FIG. 3, this rear view schematic representation illustrates a digital calendar device 100 for both portable use and desktop use, in accordance with the embodiment of the present invention as shown in FIG. 2. The frame 30 comprises a feature 41 disposed, e.g., at its rear, for accommodating at least one battery 41 and a port 44 for accommodating the AC adapter 43.

Still referring to FIG. 3, AC power may be provided through the AC adapter 43 through the port 44. Alternatively, the electronic device 10 may be electronically coupled with the at least one battery 41.

Still referring to FIG. 3, the digital calendar device 100 is operable on either AC power via the AC adapter 43 or battery power via at least one battery 42. The electronic device 10 has a power-consumption in a range of approximately 7 W to approximately 7.7 W.

FIG. 4 is a perspective view schematic representation of a feature for mechanically supporting a digital calendar device 100 for desktop use, in accordance with the embodiments of the present invention as shown in FIGS. 1 and 2. The mechanically supporting feature may comprise a bracket 35 that pivots for propping the digital calendar device 100 on horizontal surface (not shown) and that is mountable on a vertical surface (not shown) or an angled surface (not shown), such as by a hook (not shown). The bracket 35 comprises a side having a length L in a range of approximately 130 mm and a thickness t in a range of approximately 10 mm. Alternatively, the mechanically supporting feature may comprise at least one leg (not shown) that is deployable from the frame 30.

Still referring to FIG. 4, the bracket 35 is mechanically coupled with the frame 30 such that it is pivotable in relation to the frame 30 for propping the digital calendar device 100 on horizontal surface (not shown). The mechanically supporting feature comprises a feature, e.g., a recess for facilitating mounting of the device 100 on a vertical surface (not shown) or an angled surface (not shown), such as by a hook (not shown). The alternative feature, i.e., the at least one leg may be pivotally coupled with the frame 30.

Still referring to FIG. 4, in operation, the bracket 35 pivots in relation to the frame 30 and may comprise optional detents (not shown) for allowing angular of the digital calendar device 100 in relation to the horizontal surface (not shown). Alternatively, the frame 30 may comprise detents. The mechanically supporting feature comprises a feature, e.g., a recess for facilitating mounting of the device 100 on a vertical surface (not shown) or an angled surface (not shown), such as by a nail or a hook (not shown). The alternative feature, i.e., the at least one leg may also adjustably position the angle of the frame 30.

Referring next to FIG. 5, this flowchart illustrates a method M₁ of fabricating a digital calendar device 100, generally comprising the following steps: providing an electronic device 10 having a graphic user interface, as indicated by block 1901, the electronic device 10 providing step 1902 comprising providing the electronic device 10 as being capable of receiving the random information, e.g., the at least one note from a user, as indicated by block 1902, and the electronic device 10 providing step comprising providing the electronic device 10 as being capable of running on at least one operating system, as indicated by block 1903, in accordance with another embodiment of the present invention.

Still referring to FIG. 5, the method M₁ may further comprise at least one of the following steps (not shown): providing a touch screen interface 20 for facilitating entry of the random information, e.g., the at least one note by the user; providing a structure for supporting handwriting; providing a feature for supporting speech; providing a feature for reminding the user of an upcoming event; providing at least one element, such as a frame member 30 for accommodating the electronic device and a feature, such as a bracket 35, for mechanically supporting the electronic device on a surface, such as a horizontal surface, a vertical surface, and an angled surface; providing a fortune teller software program; providing a feature for providing a date stamp; and providing a feature for providing a time stamp.

Still referring to FIG. 5, in the method M₁, the electronic device providing step comprises providing the electronic device 10 as being capable of retrieving and displaying the random information, e.g., the at least one note (not shown). The electronic device 10 providing step comprises providing the electronic device 10 with a size in a range of approximately that of a paper table calendar (not shown); and the electronic device 10 providing step comprises providing the electronic device 10 with the size in at least one dimensional range such as The size comprises at least one dimensional range, such as a width in a range of approximately 100 mm to approximately 300 mm, preferably in a width range of approximately 150 mm to approximately 200 mm, and preferably in a width of approximately 180 mm; a height in a range of approximately 75 mm to approximately 200 mm, preferably in a height range of approximately 100 mm to approximately 160 mm, and preferably in a height of approximately 130 mm; and a thickness in a range of approximately 0.1 mm to approximately 20 mm, preferably in a thickness range of approximately 5 mm to approximately 15 mm, and preferably in a thickness of approximately 10 mm. Further, the electronic device 10 providing step comprises providing the electronic device 10 as being capable of running on at least one operating system (not shown), such as a Linux° operating system, a Windows® operating system, a WinCE® operating system, a Macintosh® operating system, and any embedded operating system. The handwriting supporting feature providing step comprises providing at least one feature, such as a feature for recognizing handwriting, a feature for displaying handwriting, and a feature for translating handwriting into speech. The speech supporting feature providing step comprises providing at least one feature such as a feature for recognizing speech, a feature for transmitting speech, and a feature for translating speech into writing. The electronic device 10 providing step comprises providing at least one feature, such as a feature for storing at least one year of calendar information, a feature for providing a date stamp, and a feature for providing a time stamp. The touch screen interface 20 providing step further comprises providing a clock feature 60.

Referring next to FIG. 6, this flowchart illustrates a method M₂ of calendaring by way of a digital calendar device 100, comprising the following steps: providing an electronic device 10 having a graphic user interface, as indicated by block 2001, the electronic device 10 providing step comprising providing the electronic device 10 as being capable of receiving random information from a user, as indicated by block 2002, and the electronic device 10 providing step comprising providing the electronic device 10 as being capable of running on at least one operating system, as indicated by block 2003; and entering the random information into the electronic device 10 by the user through the graphic user interface, as indicated by block 2004. The method M₂ further comprises providing a feature for retrieving and displaying the random information, wherein the random information comprises at least one element, such as at least one note, a name, an address, a telephone number, a cellular phone number, and an e-mail address, and wherein the retrieving and displaying feature providing step comprises providing at least one element, such as a liquid crystal display and a plasma display panel, as indicated by block 2005. The method M₂ further comprises retrieving and displaying the random information from the electronic device by the user via the retrieving and displaying feature, as indicated by block 2006.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a system or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, that various changes and modifications in form, material, and fabrication material detail may be made, without departing from the spirit and scope of the invention as set forth in the appended claims, should be readily apparent to those of ordinary skill in the art.

### INDUSTRIAL APPLICABILITY

The present invention generally industrially applies to calendars. More specifically, the present invention industrially applies to calendar devices and methods. Even more specifically, the present invention industrially applies to electronic calendar devices and methods.

What is claimed:

1. A digital calendar device, comprising:
an electronic device having a graphic user interface,
the electronic device capable of receiving random information from a user, and
the electronic device capable of running on at least one operating system.

2. The device of claim 1, further comprising means for retrieving and displaying the random information,
wherein the random information comprises at least one element selected from a group consisting essentially of at least one note, a name, an address, a telephone number, a cellular phone number, and an e-mail address, and
wherein the retrieving and displaying means comprises at least one element selected from a group consisting essentially of a liquid crystal display and a plasma display panel.

3. The device of claim 1, wherein the electronic device comprises a size in a range of approximately that of a paper table calendar.

4. The device of claim 3, wherein the size comprises at least one dimensional range selected from a group consisting essentially of:
a width in a range of approximately 150 mm to approximately 200 mm;
a height in a range of approximately 100 mm to approximately 160 mm; and
a thickness in a range of approximately 0.1 mm to approximately 15 mm.

5. The device of claim 1, wherein the at least one operating system comprises at least one element selected from a group consisting essentially of a Linux® operating system, a Windows® operating system, a WinCE® operating system, a Macintosh® operating system, and any embedded operating system.

6. The device of claim 1, further comprising a touch screen interface, having a calendar feature, for facilitating entry of the random information by the user, wherein the calendar feature comprises a graphical representation of at least one time period selected from a group consisting essentially of a period of at least one second, a period of at least one minute, a period of at least one hour, a period of at least one day, a period of at least one week, a period of at least one month, and a period of at least one year,

7. The device of claim 1, further comprising means for supporting handwriting for facilitating entry of the random information.

8. The device of claim 1, further comprising means for supporting speech for facilitating entry of the random information.

9. The device of claim 7, wherein the handwriting supporting means comprises at least one feature selected from a group consisting essentially of means for recognizing handwriting, means for displaying handwriting, and means for translating handwriting into speech.

10. The device of claim 8, wherein the speech supporting means comprises at least one feature selected from a group consisting essentially of means for recognizing speech, means for transmitting speech, and means for translating speech into writing.

11. The device of claim 1, further comprising means for reminding the user of an upcoming event.

12. The device of claim 1, further comprising a fortune teller software program for providing future information,
wherein the future information comprises at least one element selected from a group consisting essentially of at least one horoscope, at least one lucky number, at least one unlucky number, advice regarding avoiding an unlucky event, a fortune, and
wherein the future information is indicated in at least one manner selected from a group consisting essentially of a visual indication and an audible indication.

13. The device of claim 1, further comprising at least one element selected from a group consisting essentially of a frame member for accommodating the electronic device and means for mechanically supporting the electronic device on at least one surface selected from a group consisting essentially of a horizontal surface, a vertical surface, and an angled surface.

14. The device of claim 1, wherein the electronic device comprises at least one feature selected from a group consisting essentially of means for storing at least one year of calendar information, means for providing a date stamp, and means for providing a time stamp.

15. The device of claim 6, wherein the touch screen interface further comprises a clock feature.

16. The device of claim 15, wherein the clock feature comprises at least one element selected from a group consisting essentially of an atomic clock for precise automatic synchronization and an alarm feature.

17. The device of claim 1, further comprising at least one element selected from a group consisting essentially of a stylus for facilitating entry of the random information into the electronic device, an on-screen keyboard for facilitating entry of the random information into the electronic device, a USB port for facilitating transmission of the random information between the electronic device and a computer, a memory device for facilitating transmission of the random information between the electronic device and a computer, a memory card for facilitating transmission of the random information between the electronic device and a computer, and an automatic orientation sensor for self-orienting the electronic device on at least one surface.

18. The device of claim 1, further comprising:
means for retrieving and displaying the random information;
means for supporting handwriting for facilitating entry of the random information;
means for supporting speech for facilitating entry of the random information;
a touch screen interface, having a calendar feature, for facilitating entry of the random information by the user, wherein the calendar feature comprises a graphical representation of at least one time period selected from a group consisting essentially of a period of at least one second, a period of at least one minute, a period of at least one hour, a period of at least one day, a period of at least one week, a period of at least one month, and a period of at least one year;
means for reminding the user of an upcoming event;
a fortune teller software program for providing future information;
at least one element selected from a group consisting essentially of a frame member for accommodating the electronic device and means for mechanically supporting the electronic device on at least one surface selected from a group consisting essentially of a horizontal surface, a vertical surface, and an angled surface; and
at least one element selected from a group consisting essentially of a stylus for facilitating entry of the random information into the electronic device, an on-screen keyboard for facilitating entry of the random information into the electronic device, a USB port for facilitating transmission of the random information between the electronic device and a computer, a memory device for facilitating transmission of the random information between the electronic device and a computer, a memory card for facilitating transmission of the random information between the electronic device and a computer, and an automatic orientation sensor for self-orienting the electronic device on at least one surface,
wherein the random information comprises at least one element selected from a group consisting essentially of at least one note, a name, an address, a telephone number, a cellular phone number, and an e-mail address,
wherein the retrieving and displaying means comprises at least one element selected from a group consisting essentially of a liquid crystal display and a plasma display panel,
wherein the electronic device comprises a size in a range of approximately that of a paper table calendar,
wherein the at least one operating system comprises at least one element selected from a group consisting essentially of a Linux® operating system, a Windows® operating system, a WinCE® operating system, a Macintosh® operating system, and any embedded operating system,
wherein the handwriting supporting means comprises at least one feature selected from a group consisting essentially of means for recognizing handwriting, means for displaying handwriting, and means for translating handwriting into speech,
wherein the speech supporting means comprises at least one feature selected from a group consisting essentially of means for recognizing speech, means for transmitting speech, and means for translating speech into writing,
wherein the future information comprises at least one element selected from a group consisting essentially of at least one horoscope, at least one lucky number, at least one unlucky number, advice regarding avoiding an unlucky event, a fortune,
wherein the future information is indicated in at least one manner selected from a group consisting essentially of a visual indication and an audible indication,
wherein the electronic device comprises at least one feature selected from a group consisting essentially of means for storing at least one year of calendar information, means for providing a date stamp, and means for providing a time stamp,
wherein the touch screen interface further comprises a clock feature, and
wherein the clock feature comprises at least one element selected from a group consisting essentially of an atomic clock for precise automatic synchronization and an alarm feature.

19. A method of fabricating a digital calendar device, comprising:
an electronic device having a graphic user interface,
the electronic device capable of receiving random information from a user, and
the electronic device capable of running on at least one operating system.

20. The method of claim 19, further comprising providing means for retrieving and displaying the random information,
wherein the random information comprises at least one element selected from a group consisting essentially of at least one note, a name, an address, a telephone number, a cellular phone number, and an e-mail address, and
wherein the retrieving and displaying means providing step comprises providing at least one element selected from a group consisting essentially of a liquid crystal display and a plasma display panel.

21. The method of claim 19, wherein the electronic device providing step comprises providing the electronic device in a size in a range of approximately that of a paper table calendar.

22. The method of claim 21, wherein the electronic device providing step comprises providing the electronic device in the size comprising at least one dimensional range selected from a group consisting essentially of:
a width in a range of approximately 150 mm to approximately 200 mm;
a height in a range of approximately 100 mm to approximately 160 mm; and
a thickness in a range of approximately 0.1 mm to approximately 15 mm

23. The method of claim 19, wherein the at least one operating system providing step comprises providing at least one element selected from a group consisting essentially of a Linux® operating system, a Windows® operating system, a WinCE® operating system, a Macintosh® operating system, and any embedded operating system.

24. The method of claim 19, further comprising providing a touch screen interface, having a calendar feature, for facilitating entry of the random information by the user, wherein the touch screen interface providing step comprises providing the calendar feature comprising a graphical representation of at least one time period selected from a group consisting essentially of a period of at least one second, a period of at least one minute, a period of at least one hour, a period of at least one day, a period of at least one week, a period of at least one month, and a period of at least one year,

25. The method of claim 19, further comprising providing means for supporting handwriting for facilitating entry of the random information.

26. The method of claim 19, further comprising providing means for supporting speech for facilitating entry of the random information.

27. The method of claim 25, wherein the handwriting supporting means providing step comprises providing at least one feature selected from a group consisting essentially of means for recognizing handwriting, means for displaying handwriting, and means for translating handwriting into speech.

28. The method of claim 26, wherein the speech supporting means providing step comprises providing at least one feature selected from a group consisting essentially of means for recognizing speech, means for transmitting speech, and means for translating speech into writing.

29. The method of claim 19, further comprising providing means for reminding the user of an upcoming event.

30. The method of claim 19, further comprising providing a fortune teller software program for providing future information,
wherein the fortune teller software program providing step comprises providing the future information comprising at least one element selected from a group consisting essentially of at least one horoscope, at least one lucky number, at least one unlucky number, advice regarding avoiding an unlucky event, a fortune, and
wherein the fortune teller software program providing step comprises providing the future information as indicated in at least one manner selected from a group consisting essentially of a visual indication and an audible indication.

31. The method of claim 19, further comprising providing at least one element selected from a group consisting essentially of a frame member for accommodating the electronic device and means for mechanically supporting the electronic device on at least one surface selected from a group consisting essentially of a horizontal surface, a vertical surface, and an angled surface.

32. The method of claim 19, wherein the electronic device providing step comprises providing at least one feature selected from a group consisting essentially of means for storing at least one year of calendar information, means for providing a date stamp, and means for providing a time stamp.

33. The method of claim 24, wherein the touch screen interface providing step further comprises providing a clock feature.

34. The device of claim 33, wherein the clock feature providing step comprises providing at least one element selected from a group consisting essentially of an atomic clock for precise automatic synchronization and an alarm feature.

35. The method of claim 19, further comprising providing at least one element selected from a group consisting essentially of a stylus for facilitating entry of the random information into the electronic device, an on-screen keyboard for facilitating entry of the random information into the electronic device, a USB port for facilitating transmission of the random information between the electronic device and a computer, a memory device for facilitating transmission of the random information between the electronic device and a computer, a memory card for facilitating transmission of the random information between the electronic device and a computer, and an automatic orientation sensor for self-orienting the electronic device on at least one surface.

36. The method of claim 19, further comprising:
providing means for retrieving and displaying the random information;
providing means for supporting handwriting for facilitating entry of the random information;
providing means for supporting speech for facilitating entry of the random information;
providing a touch screen interface, having a calendar feature, for facilitating entry of the random information by the user, wherein the touch screen interface providing step comprises providing the calendar feature comprising a graphical representation of at least one time period selected from a group consisting essentially of a period of at least one second, a period of at least one minute, a period of at least one hour, a period of at least one day, a period of at least one week, a period of at least one month, and a period of at least one year;
providing means for reminding the user of an upcoming event;
providing a fortune teller software program for providing future information;
providing at least one element selected from a group consisting essentially of a frame member for accommodating the electronic device and means for mechanically supporting the electronic device on at least one surface selected from a group consisting essentially of a horizontal surface, a vertical surface, and an angled surface; and
providing at least one element selected from a group consisting essentially of a stylus for facilitating entry of the random information into the electronic device, an on-screen keyboard for facilitating entry of the random information into the electronic device, a USB port for facilitating transmission of the random information between the electronic device and a computer, a memory device for facilitating transmission of the random information between the electronic device and a computer, a memory card for facilitating transmission of the random information between the electronic device and a computer, and an automatic orientation sensor for self-orienting the electronic device on at least one surface,
wherein the random information comprises at least one element selected from a group consisting essentially of at least one note, a name, an address, a telephone number, a cellular phone number, and an e-mail address,
wherein the retrieving and displaying means providing step comprises providing at least one element selected from a group consisting essentially of a liquid crystal display and a plasma display panel,
wherein the electronic device providing step comprises providing a size in a range of approximately that of a paper table calendar,
wherein the at least one operating system providing step comprises providing at least one element selected from a group consisting essentially of a Linux® operating system, a Windows® operating system, a WinCE® operating system, a Macintosh® operating system, and any embedded operating system,
wherein the handwriting supporting means providing step comprises providing at least one feature selected from a group consisting essentially of means for recognizing handwriting, means for displaying handwriting, and means for translating handwriting into speech,
wherein the speech supporting means providing step comprises providing at least one feature selected from a group consisting essentially of means for recognizing speech, means for transmitting speech, and means for translating speech into writing,
wherein the fortune teller software program providing step comprises providing the future information comprising at least one element selected from a group consisting essentially of at least one horoscope, at least one lucky number, at least one unlucky number, advice regarding avoiding an unlucky event, a fortune,
wherein the fortune teller software program providing step comprises providing the future information as indicated in at least one manner selected from a group consisting essentially of a visual indication and an audible indication,
wherein the electronic device providing step comprises providing at least one feature selected from a group consisting essentially of means for storing at least one year of calendar information, means for providing a date stamp, and means for providing a time stamp,
wherein the touch screen interface providing step further comprises providing a clock feature, and
wherein the clock feature providing step comprises providing at least one element selected from a group consisting essentially of an atomic clock for precise automatic synchronization and an alarm feature.

37. A method of calendaring by way of a digital calendar device, comprising:
providing an electronic device having a graphic user interface,
the electronic device providing step comprising providing the electronic device as being capable of receiving random information from a user, and
the electronic device providing step comprising providing the electronic device as being capable of running on at least one operating system; and
entering the random information into the electronic device by the user through the graphic user interface.

38. The method of claim 37, further comprising providing means for retrieving and displaying the random information,
wherein the random information comprises at least one element selected from a group consisting essentially of at least one note, a name, an address, a telephone number, a cellular phone number, and an e-mail address, and
wherein the retrieving and displaying means providing step comprises providing at least one element selected from a group consisting essentially of a liquid crystal display and a plasma display panel.

39. The method of claim 38, further comprising retrieving and displaying the random information from the electronic device by the user via the retrieving and displaying means.
